(19) United States
(12) Patent Application Publication
(10) Pub. No.: US 2012/0138714 A1
(43) Pub. Date: Jun. 7, 2012

(54) Electrospray Delivery Device

(76) Inventors: Stephen C. Jacobsen, Salt Lake City, UT (US); Marc X. Olivier, Salt Lake City, UT (US)

(21) Appl. No.: 12/959,170

(22) Filed: Dec. 2, 2010

(51) Int. Cl. F23D 11/32; B23P 17/04

(52) U.S. Cl. 239/690; 29/890.09

(57) ABSTRACT

An electro-spray delivery device for delivering a stream of charged micro-droplets of a conductive fluid, and which a capillary tube having a proximal end in fluid communication with a source of conductive fluid and a distal end opposite the proximal end. The device also includes a solid guide wire coaxially disposed at least partially within the capillary tube to form an annular passage therein, and which has a distal tip projecting beyond the distal end of the capillary tube. At least one of the capillary tube and guide wire is conductive and in electrical communication with a high-voltage source to electrically charge the conductive fluid flowing through the annular passage and wetting the distal tip of the guide wire. The electrospray delivery device further includes a grounding electrode that is located a predetermined distance from the distal tip of the guide wire and which is in electrical communication with a source of ground. A voltage differential between the charged fluid and the grounding electrode draws the charged fluid away from the distal end of the capillary tube to form a cone jet about the end face of the distal tip discharging a stream of charged micro-droplets.

### FIELD OF THE INVENTION

The present invention relates generally to the field of electrospray systems, and more particularly to an electrospray delivery device, such as for fuel injectors.

### BACKGROUND OF THE INVENTION AND RELATED ART

The method of using a high voltage electric field to atomize a liquid flowing through a narrow nozzle into a mist of small, uniformly-sized and charged droplets has been known in the art for nearly a century. Originally known as electrohydrodynamic atomization, the electric field is created by connecting a conductive capillary tube to one side of an electric circuit to form a hollow electrode through which a conductive fluid must pass. As the fluid travels the length of the capillary, either under the influence of back pressure or through capillary action, it can acquire a charge. At the outlet of the capillary tube the fluid collects to form a convex meniscus, wetting the entire circumference of the capillary outlet. A counter-electrode, connected to ground, is placed some distance away from the capillary tip to complete the electrical field.

The electrohydrodynamic process is highly-dependent on the strength of the electric field, and hence the voltage differential between the capillary electrode and the counter electrode. If the voltage is not high enough, the fluid will merely grow at the tip of the capillary tube to form a drop that eventually drips off. However, if the voltage is significantly strong the interaction between the conductive fluid and the electric field will cause the fluid at the capillary tip to form into a cone pointing towards the counter electrode. The electrical field then imposes sheer forces on the outer surface of this cone, forcing the outer layers of fluid to slough off and form a microjet directed towards the counter-electrode. The velocity of the microjet fluid is quite fast, on the order to 10 to 50 meters/second. As the microjet fluid travels away from the capillary tip it begins to break up into fine droplets having a uniform size, with each droplet maintaining the strong electrical charge it picked up while traveling through the capillary tube.

If a hole or passage is located in the counter-electrode and aligned with the microjet, the droplets will pass through the counter electrode into the space beyond. During this passage the individual droplets give up both a significant portion of their charge and a large percentage of their velocity. However, the droplets retain enough charge so that when their forward velocity stops, they begin to interact by repelling any nearby droplets having the same like charge, which prevents the individual droplets from coalescing into larger drops. This results in a fine mist of uniformly sized and charged droplets which can be utilized in a variety of ways.

This process of electrohydrodynamic atomization is commonly referred to as electrospray, and has many practical applications. It has been utilized in the application of thin film coatings for semiconductors, thick film coatings with inkjet printing and powder deposition. It has found use in the medical field as a nebulizer for the delivery of medication. And as a source of ionization, in which ions present in the liquid are transformed into gas phase ions through the process of atmospheric pressure ionization, electrospray is notably combined with the analytical technique of mass spectrometry to form electrospray ionization-mass spectrometry. This method enjoys nearly universal application for chemical analysis, finding wide use in chemical manufacturing, analytical chemistry, environmental chemistry, and perhaps most importantly in the life sciences, where it plays a central role in pharmaceutical drug discovery and development.

### SUMMARY OF THE INVENTION

In accordance with one representative embodiment described herein, an electro-spray delivery device is provided for delivering a stream of charged micro-droplets of a conductive fluid. The electrospray delivery device includes a capillary tube having a proximal end in fluid communication with a source of conductive fluid and a distal end opposite the proximal end. The delivery device also includes a solid guide wire that is coaxially disposed at least partially within the capillary tube to form an annular passage therein, and which has a distal tip projecting beyond the distal end of the capillary tube. At least one of the capillary tube and guide wire is conductive and in electrical communication with a high-voltage source so that the conductive fluid receives an electrical charge as it flows through the annular passage and wets the distal tip of the guide wire. The electrospray delivery device further includes a grounding electrode that is located a predetermined distance from the distal tip of the guide wire and which is in electrical communication with a source of ground. A voltage differential between the charged fluid and the grounding electrode draws the charged fluid away from the distal end of the capillary tube to form a cone jet about the end face of the distal tip of the guide wire discharging a stream of charged micro-droplets.

In accordance with another representative embodiment described herein, an electrospray system is provided for delivering a stream of charged micro-droplets of a conductive fluid into an atomization chamber. The electrospray system includes an electrospray delivery device comprising a capillary tube having a proximal end in fluid communication with a source of conductive fluid and a distal end extending towards the atomization chamber. The delivery device also includes a solid guide wire that is coaxially disposed at least partially within the capillary tube to form an annular passage therein, and which has a distal tip projecting beyond the distal end of the capillary tube. At least one of the capillary tube and guide wire is conductive and in electrical communication with a high-voltage source so that the conductive fluid receives an electrical charge as it flows through the annular passage and wets the distal tip of the guide wire. The delivery device further includes a grounding electrode that is located a predetermined distance from the distal tip of the guide wire, and which is in electrical communication with a source of ground, and which has at least one thru-passage coaxially aligned with the capillary tube and guide wire.

The electrospray system further includes an atomization chamber located adjacent the grounding grid and opposite the electrospray delivery device. A voltage differential between the charged fluid and the grounding electrode draws the charged fluid away from the distal end of the capillary tube to form a cone jet about the end face of the distal tip of the guide wire directing a stream of charged micro-droplets through the at least one thru-passage and into the atomization chamber.

In accordance with yet another representative embodiment described herein, a method is provided for making an electrospray delivery device for delivering a stream of charged micro-droplets of a conductive fluid. The method includes the steps of obtaining a capillary tube having a proximal end and a distal end, and placing a proximal end of the capillary tube into fluid communication with a source of conductive fluid. The method also includes disposing a solid guide wire at least partially within the capillary tube to form an annular passage therein, and with a distal tip of the guide wire projecting beyond a distal end of the capillary tube, and with least one of the capillary tube and guide wire being conductive and in electrical communication with a high-voltage source to electrically charge the conductive fluid flowing through the annular passage. The method further includes the step of locating a grounding electrode in electrical communication with a source of ground at a predetermined distance from the distal end of the electrospray delivery device, so that a voltage differential between the charged conductive fluid and the grounding electrode pulls the charged fluid away from the distal end of the capillary tube and into a cone jet about the end face of the distal tip of the guide wire discharging an outwardly-directed stream of charged micro-droplets.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 is a perspective view of an electrospray delivery device for delivering a stream of charged micro-droplets of a conductive fluid, in accordance with one representative embodiment;

FIGS. 2A-2C together illustrate top, side and end schematic views of the capillary tube of FIG. 1;

FIG. 3 illustrates a close-up cross-sectional view of the distal end of the capillary tube of FIG. 1;

FIGS. 4A-4C together illustrate various representative embodiments of the distal tip of the guide wire of FIG. 1;

FIGS. 5A-5B together illustrate various representative embodiments of the grounding electrode of FIG. 1;

FIGS. 6A-6D together illustrate the movement of a conductive fluid through the capillary tube of FIG. 1 under various voltage differentials;

FIG. 7 illustrates an electrospray delivery device for delivering one or more streams of charged micro-droplets of a conductive fluid, in accordance with another representative embodiment;

FIG. 8 is a flowchart depicting a method of making an electrospray delivery device for delivering a stream of charged micro-droplets of a conductive fluid, in accordance with yet another representative embodiment; and

FIG. 9 illustrates the distal tip of the guide wire and the grounding electrode of yet another representative embodiment of the electrospray delivery device.

### DETAILED DESCRIPTION OF EXEMPLARY EMBODIMENTS

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments, and to sufficiently enable one skilled in the art to practice the invention. Accordingly, the scope of the present invention is to be defined solely by the appended claims.

Furthermore, the following detailed description and representative embodiments of the invention will best be understood with reference to the accompanying drawings, wherein the elements and features of the embodiments are designated by numerals throughout.

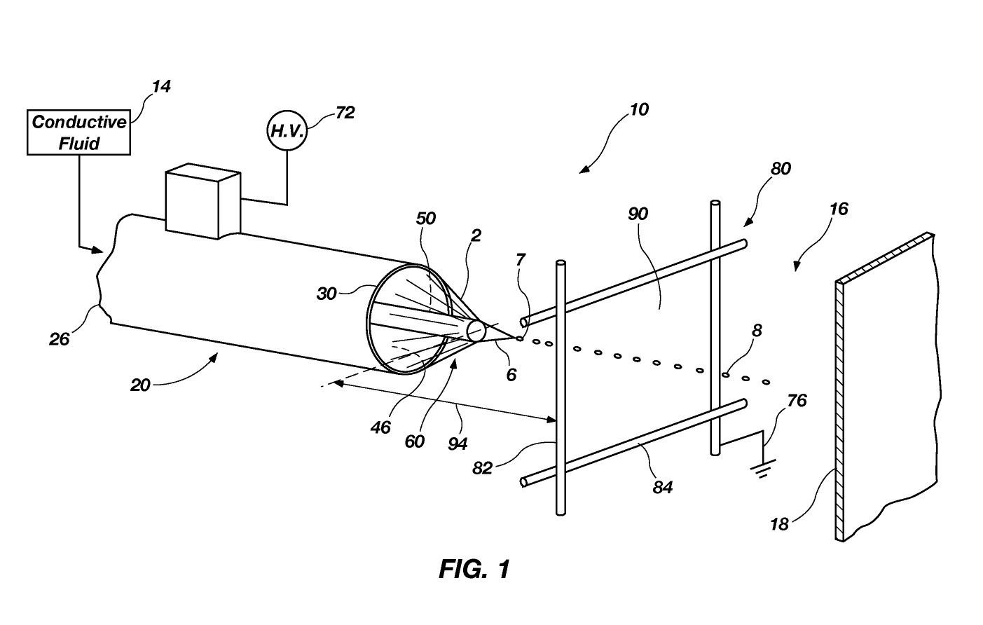

Illustrated in FIGS. 1-9 are several exemplary embodiments of an electrospray delivery device for delivering a stream of charged micro-droplets of a conductive fluid, and which embodiments can also include one or more methods of making an electrospray delivery device for delivering a stream of charged micro-droplets of a conductive fluid. As described herein, the delivery device provides several significant advantages and benefits over other devices and methods for delivering a stream of charged micro-droplets of a conductive fluid. However, the recited advantages are not meant to be limiting in any way, as one skilled in the art will appreciate that other advantages may also be realized upon practicing the present invention.

With reference to FIG. 1, illustrated therein is one embodiment of an electrospray delivery device 10 and system for delivering a stream 7 of charged micro-droplets 8 of a conductive fluid 2. The delivery device includes a capillary tube 20 having a proximal end 26 in fluid communication with a source of conductive fluid 14 and a distal end 30 which can be directed towards an atomization chamber 16 that is bounded by an outer wall 18 or surface. The electrospray delivery device also includes a solid guide wire 50 that is coaxially disposed at least partially within the capillary tube 20 to form an annular passage 46 therein, and which also has a distal tip 60 that projects beyond the distal end 30 of the capillary tube 20. The delivery device further includes a grounding electrode 80 located a predetermined distance 94 from the distal tip 60 of the guide wire 50, and which is placed in electrical communication with a source of ground 76.

Also shown in FIG. 1, one or both of the capillary tube 20 and the guide wire 50 can be conductive and placed in electrical communication with a high-voltage source 72 so that the conductive fluid 2 receives an electrical charge as it flows through the annular passage 46 and wets the distal tip 60 of the guide wire 50. Consequently, a voltage differential of sufficient magnitude between the charged fluid 2 and the grounding electrode 80 can operate to pull the charged fluid away from the distal end 30 of the capillary tube 20 and into a cone jet 6 which forms about the distal tip 60 of the guide wire 50 and which produces, at the apex of the cone 6, a high-speed stream or jet 7 of charged micro-droplets 8 directed towards the grounding electrode 80. In one aspect the grounding electrode 80 can further comprise a grounding grid 82 made from of multiple intersecting wire-type members 84 having thru-passages 90 formed there between, so that the stream of charged micro-droplets 8 can be directed through the thru-passage 90 and into the atomization chamber 16 located adjacent the grounding grid 82 but opposite the capillary tube 20.

In various aspects the conductive fluid 2 can include a wide variety of conductive fluids or liquids as used in the various electrospray applications described above, and can further include low-conductive and non-conductive liquids that have been treated with a conductive agent. For example, fuel injectors are one potential application for the electrospray delivery device 10 described herein, and common fuels having a natural conductivity that is too low for use with the electrospray delivery device, such as JP-8, can have an antistatic agent, such as DuPont/Octel Stadis 450, blended into the fuel as an additive.

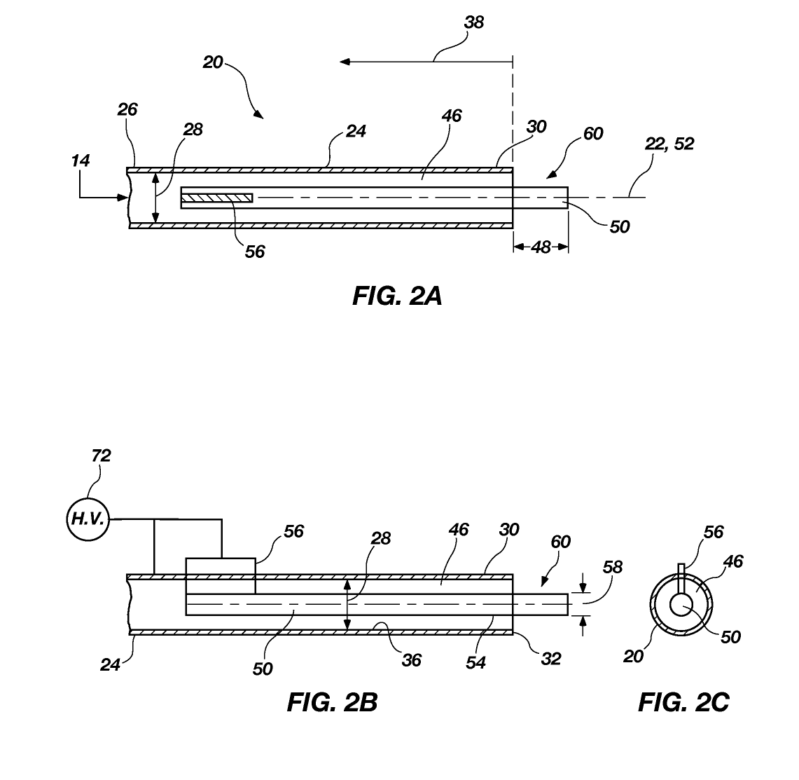

The capillary tube 20 and guide wire 30 are shown in more detail in FIGS. 2A-2C. As can be seen, the capillary tube 20 can comprise a tubular body 24 of internal diameter 28 with a longitudinal center axis 22, and having a proximal end 26 and a distal end 30. The capillary tube 20 can be quite small, and in one embodiment, can have an internal diameter 28 ranging from about 50 μm to about 200 μm.

The capillary tube can also be of sufficient length 38 in relation to its diameter 28 so that when the tubular body 24 is connected to a source of conductive fluid 14, that the conductive fluid flows naturally from the proximal end 26 to the distal end 30 under the influence of capillary action to form a meniscus of the fluid at the distal end of the tube, with little to no hydrostatic pressure at the source of conductive fluid. Nevertheless, in one aspect the source of conductive fluid 14 can also have a hydrostatic pressure which can be modulated to control the flowrate through capillary tube. Once having filled the interior volume of the capillary tube 20, however, the same surface tension forces which create the capillary action can also operate to prevent the conductive fluid from flowing further out of the distal end 30 of the capillary tube without some an externally-applied force.

As described above, the solid guide wire 50 of diameter 58 can be coaxially disposed at least partially within the capillary tube 20 to form an annular passage 46 between the external surface 54 of the guide wire and the internal surface 36 of the capillary tube. The guide wire 50 can have a distal tip 60 that projects a distance 48 beyond the distal edge 32 of the capillary tube. In the representative embodiment of the electrospray delivery device 10 shown FIGS. 2A-2C, at least one lateral guide wire base 56 can extend through a sidewall of the tubular body 24 to hold the longitudinal axis 52 of the guide wire substantially centered and coaxial within longitudinal axis 22 the capillary tube 20. It is to be appreciated, however, that other designs and configurations for supporting and centering the guide wire within the capillary tube are also possible, such as multiple lateral support bases or guide wires built up perpendicular to the plane of a substrate (as will be discussed in more detail below), etc., and can be considered to fall within the scope of the present invention.

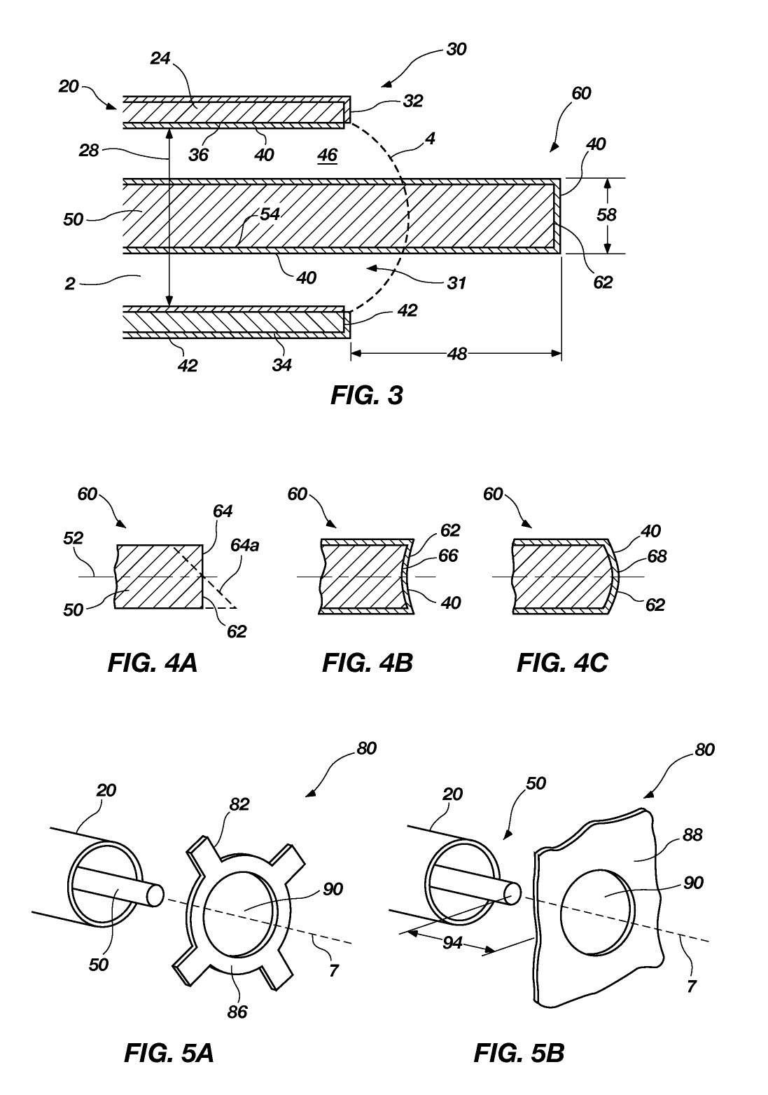

A close-up of the distal ends 30, 60 of the capillary tube 20 and the guide wire 50, respectively, is shown in FIG. 3. The distal end 60 of the guide wire 50 can extend or project beyond the distal end 30 of the capillary tube 20 a projecting distance 48. In one aspect the projecting distance 48 can be substantially greater than or equal to the internal diameter 28 of the capillary tube, so as to extend beyond the furthest potential radius of a naturally-forming meniscus 4. This can ensure that the cone of conductive fluid 2 forms about the end face 62 of the distal tip 60 of the guide wire 50, and not about the outlet opening 31 of the capillary tube 20 defined by the distal edge 32 of the tubular body 24. Because the surface area of the end face 62 of the guide wire 50 is much smaller than the area of the outlet opening, the cone jet which forms about the end face can be much smaller in size than cone jets formed in existing electrospray delivery devices, resulting in a corresponding reduction in the surface tension forces which must be overcome prior to establishing the stream of charged micro-droplets. Consequently, in one aspect the onset or threshold voltage differential required to establish the cone jet can be also be proportionately lower, such as in the range of 2.5-3.5 kilovolts.

Also shown in FIG. 3, in one aspect both the inside surface 36 of the capillary tube 20 and the outer surface 54 of the guide wire 50, including the end face 62, can be covered with a layer or coating 40 that facilitates wetting with respect to the conductive fluid, so as to attract and draw the conductive fluid through the annular passage and wet the distal tip 60 of the guide wire. In contrast, the surface of the distal edge 32 and/or the outer surface 34 of the tubular body 24 can be covered with a layer or coating 42 that is lacks an affinity to or that prevents wetting of the surface of the distal edge by the conductive fluid, so as to repel the conductive fluid away from the distal edge 32 or outer surface 34 and keep it from pooling or forming undesirable drops on other portions of the electrospray delivery device 10. Some possible examples of the hydrophoic coating include, but are not limited to polytetrafluoroethylene (PTFE), Parylene, nanostuctured titania or zirconia powder particles. Further, these hydrophibic coatings may be applied to the metallic electrode surface by different techniques, including plasma sprarying, combustion flame spraying, high velocity oxy fuel spraying, and other methods. In other aspects the solid guide wire and/or the capillary tube can be made from a material that is itself facilitates wetting with respect to the conductive fluid, and which does not require the additional layer or coating 40.

Illustrated in FIGS. 4A-4C are various representative embodiments of the distal tip 60 of the guide wire 50. For instance, the distal tip of the guide wire can have an end face 62 that is substantially planar and oriented substantially perpendicular 64 to the longitudinal axis 52 of the guide wire, as shown in FIG. 4A, or at an angle 64a such as one, while not limiting, that is of greater than or about forty-five degrees with respect to the longitudinal axis 52 of the guide wire. Moreover, as described above, the bare material forming the guide wire 50 can be itself facilitate wetting with respect to the conductive fluid and without the need for an additional coating or layer.

In other aspects of the electrospray delivery device the end face 62 of the distal tip 60 can be provided with a curved or rounded profile, such as the inwardly-curved concave profile 66 shown in FIG. 4B, or the outwardly-curved convex profile 68 shown in FIG. 4C. Also as described above, in some aspects the distal tip 60 of the guide wire, including the end face 62, may be covered with a layer or coating 40 that attracts the conductive fluid to facilitate the wetting of the end face 62.

FIGS. 5A and 5B together illustrate additional representative embodiments of the grounding electrode 80 with respect to the grounding grid 82 of FIG. 1 (e.g. comprised of wire-type members having thru-passages formed there between). For instance, FIG. 5A illustrates a grounding grid 82 comprising one or more shaped ring-members 86 also having a thru-passage formed there between, but with a more circular aspect that better matches the shape of the of the capillary tube 20 and guide wire 50, and which may thusly generate a more uniform application of the voltage differential which in turn generates a more centered and aligned stream or jet 7 of micro-droplets. Another configuration is shown in FIG. 5B, with the grounding electrode 80 comprising a grounding sheet 88 having one or more holes or thru-passages 90 formed therein for allowing the passage of the micro-droplet stream 7. In one aspect the grounding sheet embodiment 88 of the grounding electrode can comprise a thin foil of metallic material having a plurality of thru-holes cut therein using a mechanical, laser or chemical cutting or etches process, etc., and which foil sheet can then be supported a predetermined distance from the distal tip of the guide wire 50.

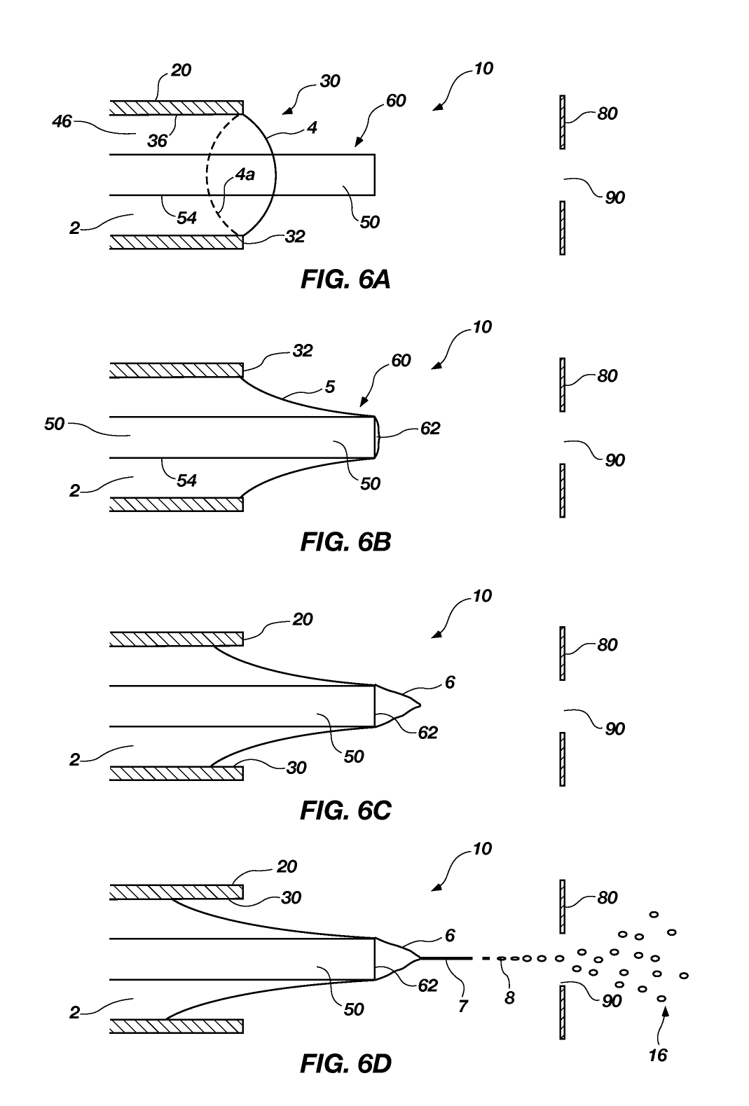

FIGS. 6A-6D together illustrate the movement of the conductive fluid 2 through electrospray delivery device 10 and system under various voltage differentials between the charged conductive fluid and a grounding electrode 80 having a thru-passage 90 formed therein. As discussed above, the conductive fluid can be drawn through the annular passage 46 between the outer surface 54 of the guide wire 50 and the internal surface 36 of the capillary tube 20 under the influence of capillary action created by the interaction between the conductive fluid and the solid surfaces (plus any wetting facilitating coating or material). In one aspect a slight modulation in the back pressure at the source of conductive fluid in communication with the proximal end of the capillary tube can also serve to assist the movement of the conductive fluid through the tube. As shown in FIG. 6A, upon reaching the distal end 30 of the capillary tube, however, the same intermolecular surface tension forces pulling the conductive fluid along the length of the capillary tube 20 can operate to restrain the fluid from flowing out the distal opening defined by the distal edge 32 of the tubular body, and instead cause the conductive fluid 2 to form a rounded convex meniscus 4, through which projects the distal tip 60 of the guide wire. Depending upon the degree of molecular interaction between the conductive fluid and itself and between the surfaces of the capillary tube, the rounded concave meniscus 4a is also possible.

In yet another aspect of the electrospray delivery device 10 illustrated in FIG. 6B, the outer surface 54 of the distal tip portion 60 of the guide wire 50 can be substantially attractive with respect to the conductive fluid 2 so that the fluid continues to flow outwardly along the guide wire 50 until it completely wets the distal tip and end face 62 of the guide wire, and thus forms a rounded concave meniscus 5 extending from the distal edge 32 of the capillary tube to the end face 62 of the guide wire. Furthermore, it is to be appreciated that the various boundary shapes for the conductive fluid at the distal end of the capillary tube 20 that are described and illustrated with reference to FIGS. 6A and 6B can be achieved with little to no voltage differential present between the conductive fluid and the grounding electrode 80.

Beginning with FIG. 6C, a moderate voltage differential (e.g. of at least about one kilovolt or greater) between the conductive fluid 2 and the grounding electrode 80 can cause a liquid cone 6 of conductive fluid to form about the end face 62 of the guide wire 50 as the electromagnetic forces draw the conductive fluid away from the distal end 30 of the capillary tube 20 and towards the grounding electrode. However, as illustrated in FIG. 6D, it is not until an onset or threshold voltage differential is reached (e.g. of about 2.5 kilovolts or greater) that the electromagnetically-induced sheer forces in the conductive fluid become sufficiently strong to pull the outer layers of the conductive fluid from off the cone 6 and into a high-speed stream or jet 7 of conductive fluid which quickly breaks up into a plurality of charged micro-droplets 8 as it moves towards the grounding electrode. As the momentum of the charged micro-droplets 8 carries them through the thru-passage 90 in the grounding electrode 80 most of the electrical charge contained within the micro-droplets is released. However, a small residual charge can remain in each micro-droplet 8 that is sufficient to repel the like-charged micro-droplets from each other and prevent them from coalescing into larger drops until the micro-droplets have completely evaporated into vapor.

In one aspect of the electrospray delivery device 10 described herein, the internal diameter of the capillary tube 20 can range in size from about 50 μm to about 200 μm, while the diameter of the guide wire 50 can range in size from about 25 μm to about 100 μm. Thus, even with the capillary tube 20 of the delivery device 10 being substantially smaller than other electrospray devices and apparatus found in the prior art, locating the base of the cone jet 6 about the end face 62 of the guide wire 50 rather than about the entire distal opening of the capillary tube can reduce the size of the cone jet even further and allow for the significantly lower threshold or onset voltage differential. Moreover, reducing the threshold voltage differential for formation of the cone jet 6 (e.g. to about 2.5 kilovolts) can move the voltage level below the range of potential arcing between the capillary tube/guide wire and the grounding electrode, which can be about 5.0 kilovolts.

Consequently, in addition to conserving energy the lower-voltage electrospray delivery device 10 describe herein may have expanded application in fuel injector systems configured to supply a quantity of fuel vapor mixed with air to a combustion chamber, and which can better avoid pre-ignition of the fuel/air mixture caused by uncontrolled arcing between the capillary tube/guide wire and the grounding electrode which can occur when the cone jet formation onset voltage differential is about 5.0 kilovolts or greater.

Being able to form a smaller cone jet 6 about the end face 62 of the guide wire 50 can be further advantageous by reducing the size of the stream 7 of charged micro-droplets 8 to an average diameter between about 5 μm to about 30 μm, whereas the average diameter of the droplets produced by other electrostatic systems is typically in the range of 150 μm to 300 μm or greater. As can be appreciated by one of skill in the art, the time for evaporation of a drop or droplet of fluid is proportional to the square of its diameter, so that halving the diameter of a drop or droplet results in a four-fold increase in the evaporation rate. Thus, in one aspect of the electrospray delivery device 10 the stream of charged micro-droplets 8 directed towards the thru-passage 90 and into the atomization chamber 16 can be configured to at least partially evaporate prior to reaching the grounding electrode 80.

In one alternative configuration shown in FIG. 9, moreover, the grounding electrode 80a can be provided with a substantially solid surface and without thru-passages formed therein, and the location of the atomization chamber 16a can be moved to the volume in between the capillary tube 20/guide wire 50 assembly and the grounding electrode 80a, so as to further reduce the size of the electrospray system. In this configuration the stream of charged micro-droplets 8 generated by the electrospray delivery device 10a and directed into the atomization chamber 16a can be configured to completely evaporate prior to reaching the grounding electrode 80a.

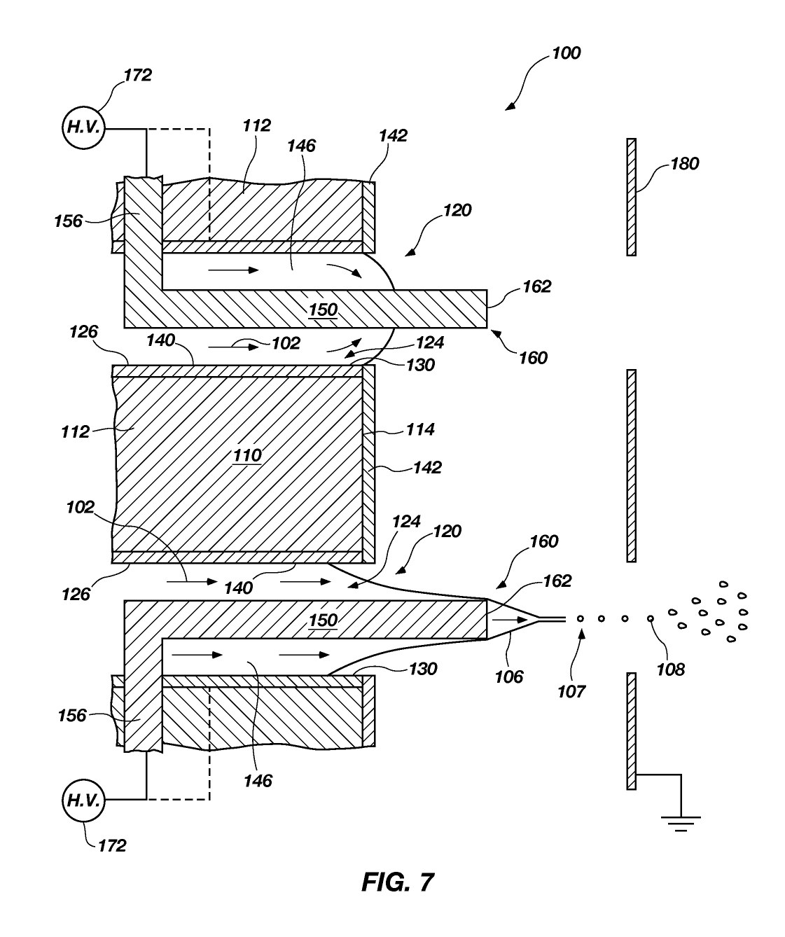

FIG. 7 illustrates another representative embodiment of an electrospray delivery device 100 for delivering one or more streams 107 of charged micro-droplets 108 of a conductive fluid. The electrospray delivery device 100 can have one or more capillary tubes 120, each having a proximal end 126 placed in fluid communication with a source of conductive fluid and a distal end 130 opposite the proximal end. Each capillary tube 120 also includes a solid guide wire 150 coaxially disposed at least partially within the capillary tube to form an annular passage 146, and with the guide wire having a distal tip 160 projecting beyond the distal end 130 of the capillary tube. At least one of the capillary tube 120 and guide wire 150 is conductive and in electrical communication with a high-voltage source 172 so that the conductive fluid 102 receives an electrical charge as it flows through the annular passage 146 and wets the distal tip 160 of the guide wire.

In contrast to the previously described embodiment having a capillary tube formed from a separate tubular body, however, each of the capillary tubes 120 in the electrospray delivery device 100 can instead comprise a passage or channel 124 formed through a base substrate 110 built up from one or more layers of material, such as base layer 112 and outer layer 142. For the embodiments having more than one capillary tube 120, the plurality of channels 124 can share a common base substrate 110, as shown in FIG. 7.

Additionally, a grounding electrode 180 or grid that is similar to the one or more grounding electrodes described above, and which is in electrical communication with a source of ground, is also spaced a predetermined distance from the outer surface 114 of the base substrate 110 or the distal tips 160 of the guide wires 150. The high-voltage source 172 can be selectively activated so that a voltage differential between the charged conductive fluid and the grounding electrode can draw the conductive fluid away from the distal end 130 of the capillary tube to form a liquid cone 106 about an end face 162 of the distal tip 160, and from the apex of which is discharged a jet or stream 107 of charged micro-droplets 108.

As may be appreciated by one of skill in the art, the electrospray delivery device 100 having one or more passages or channels 124 formed through an insulating or non-conductive base substrate 110 which itself has been built up from one or more layers of material, and with conductive features such as the guide wire 150 embedded therein, can lend itself to the readily-available MEMS (MicroElectroMechanical Systems) materials and manufacturing techniques, including physical and chemical deposition, lithography and etching. However, other materials, configurations and manufacturing techniques are also possible and may be considered to fall within the scope of the present invention.

Each capillary tube 120 or passage 124 can be of sufficient length in relationship to its diameter so that once connected to the source of conductive fluid, the liquid flows naturally from the proximal end 126 to the distal end 130 under the influence of capillary action to form a meniscus of the fluid at the distal end of the tube, with little to no hydrostatic pressure at the source of conductive fluid. Nevertheless, in one aspect the source of conductive fluid can also have a hydrostatic pressure which can be modulated to control the flowrate of the conductive fluid through capillary tube.

While the one or more material(s) forming the base substrate 110 can be non-conductive and insulating, in one aspect the channel 124 forming the capillary tube 120 can be lined with a layer or coating of conductive and/or wetting facilitating material 140 which, in the conductive case, can be placed in electrical communication with the high-voltage source. In the case of the layer or coating 140 being attractive with respect to the conductive fluid, it can attract and help draw the conductive fluid 102 from a source of conductive fluid and through the annular passage 146 to the distal end 130 of the capillary tube.

In one aspect the proximal end 156 of the solid guide wire 150 can be embedded within the base substrate, and can extend through the internal sidewall of the channel 124 to be supported coaxially within capillary tube 120. The material forming the guide wire 150 may also be conductive and/or attractive with respect to the conductive fluid 102, and can be placed in electrical communication with a high-voltage source in the conductive case, and can attract and help draw the conductive fluid through the annular passage 146 and wet the distal tip 160 of the guide wire 150.

Furthermore, as also illustrated in FIG. 7, the outer surface 114 of the base substrate 110 can be covered with a layer or coating 142 that is resistant with respect to the conductive fluid, so as to repel the conductive fluid away from the outer surface 114 and keep it from pooling or forming otherwise undesirable drops on other portions of the electrospray delivery device 100.

The electrospray delivery device 100 having multiple capillary tubes 120 can also be configured to selectively deliver one or more streams 107 of charged micro-droplets 108 of the conductive fluid. For instance, each of the guide wires 150 can be conductive and individually connected to the high-voltage source 172 and configured for selective activation, so that a stream of charge micro-droplets can be produced from an active first capillary tube/guide wire assembly and not from an inactive second capillary tube/guide wire assembly adjacent to the first. Thus, in one aspect, the electrospray delivery device 100 having multiple capillary tubes 120/guide wire 150 assemblies, can be scalable to include a large number of capillary tubes/guide wire assemblies which can be configured to deliver a selectively-controllable amount of conductive fluid depending on the number of capillary tube/guide wire assemblies activated at any given time.

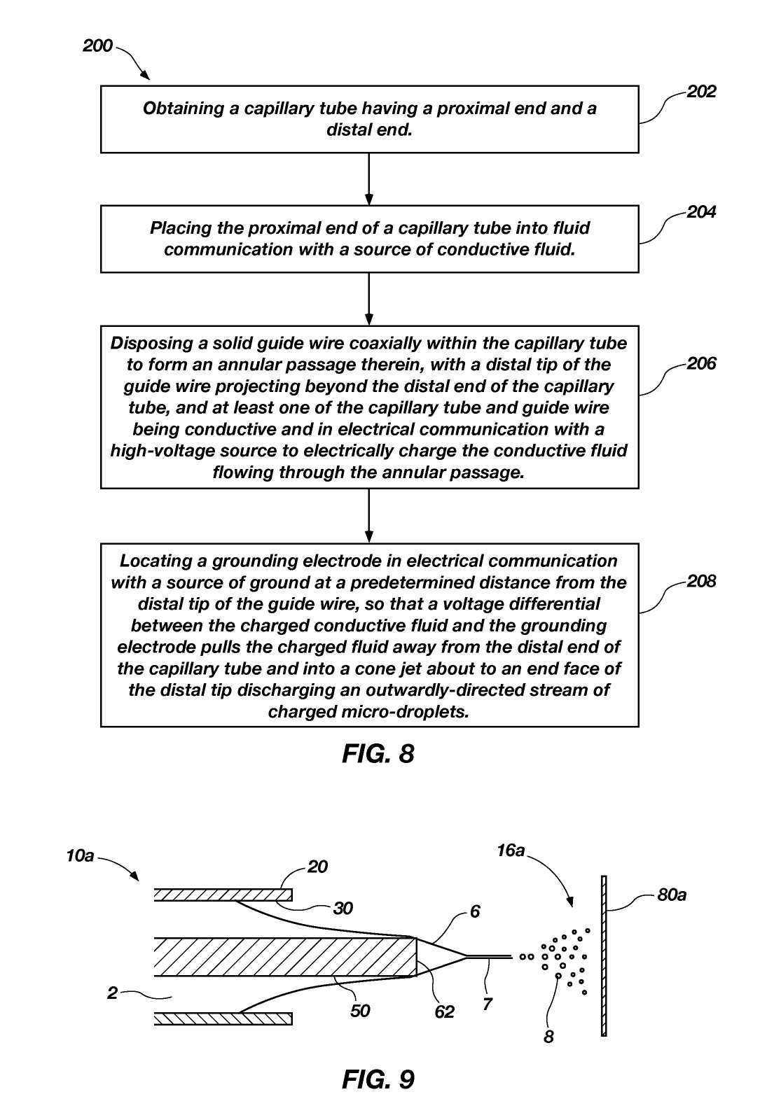

FIG. 8 is a flowchart depicting a method 200 of making an electrospray delivery device for delivering a stream of charged micro-droplets of a conductive fluid, in accordance with yet another representative embodiment. The method includes the steps of obtaining 202 a capillary tube having a proximal end and a distal end, and placing 204 the proximal end of the capillary tube into fluid communication with a source of conductive fluid. The method also includes the step of disposing 206 a solid guide wire at least partially within the capillary tube to form an annular passage therein, with a distal tip of the guide wire projecting beyond the distal end of the capillary tube, and with at least one of the capillary tube and the guide wire being conductive and in electrical communication with a high-voltage source to electrically charge any conductive fluid flowing through the annular passage. The method further includes the step of locating 208 a grounding electrode in electrical communication with a source of ground at a predetermined distance from the distal tip of the guide wire, so that a voltage differential between the charged conductive fluid and the grounding electrode pulls the charged fluid away from the distal end of the capillary tube and into a cone jet about the end face of the distal tip of the guide wire discharging an outwardly-directed stream of charged micro-droplets.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function limitation are expressly recited in the description herein. Accordingly, the scope of the invention should be determined solely by the appended claims and their legal equivalents, rather than by the descriptions and examples given above.

What is claimed and desired to be secured by Letters Patent is:

1) An electro spray delivery device for delivering a stream of charged micro-droplets of a conductive fluid, comprising:
a capillary tube having a proximal end in fluid communication with a source of conductive fluid and a distal end;
a solid guide wire coaxially disposed at least partially within the capillary tube to form an annular passage therein and having a distal tip projecting beyond the distal end of the capillary tube; and
a grounding electrode located a predetermined distance from the distal tip of the guide wire in electrical communication with a source of ground,
wherein the conductive fluid receives an electrical charge as it flows through the annular passage and wets the distal tip of the guide wire, and
wherein a voltage differential between the charged fluid and the grounding electrode draws the charged fluid away from the distal end of the capillary tube to form a cone jet about an end face of the distal tip discharging a stream of charged micro-droplets.

2) The electro spray delivery device of claim 1, wherein the end face of the distal tip is substantially planar.

3) (canceled)

4) The electro spray delivery device of claim 1, wherein the end face of the distal tip has a rounded profile selected from the group consisting of an outwardly-curved convex shape and an inwardly-curved concave shape.

5) The electro spray delivery device of claim 1, wherein the capillary tube is conductive and in electrical communication with a high-voltage source.

6) The electro spray delivery device of claim 1, wherein the guide wire is conductive and in electrical communication with a high-voltage source.

7) The electro spray delivery device of claim 1, wherein an internal diameter of the capillary tube ranges between about 50 μm and about 200 μm.

8) The electro spray delivery device of claim 1, wherein an external diameter of the guide wire ranges between about 25 μm and about 100 μm.

9) The electro spray delivery device of claim 1, wherein an internal surface of the capillary tube and an external surface of the guide wire are attractive with respect to the conductive fluid to draw the conductive fluid through the tube through capillary action.

10) The electro spray delivery device of claim 1, wherein the distal end of the capillary tube lacks an affinity to the conductive fluid.

11) The electro spray delivery device of claim 1, wherein a hydrostatic pressure of the source of conductive fluid is modulated to control a flow rate of the conductive fluid through the capillary tube.

12) The electro spray delivery device of claim 1, wherein the grounding electrode further comprises a grounding grid located a predetermined distance from the distal tip of the guide wire and having at least one thru-passage coaxially aligned with the capillary tube and guide wire.

13) The electrospray delivery device of claim 12, wherein the grounding grid is aligned to the guide wire so that the voltage differential between the conductive fluid and the grounding grid pulls the stream of charged micro-droplets through the at least one thru-passage and into an atomization chamber.

14) The electro spray delivery device of claim 1, wherein an average diameter of the charged micro-droplets ranges from about 5 μm and about 30 μm.

15) The electro spray delivery device of claim 1, wherein at least one of the capillary tube and guide wire are conductive structures etched into a MEMS substrate having fluid passages and conductive vias formed therein.

16) The electrospray delivery device of claim 15, wherein an exterior surface of the MEMS substrate surrounding the capillary tube and guide wire lacks an affinity to the conductive fluid.

17) An electrospray system for delivering a stream of charged micro-droplets of a conductive fluid into an atomization chamber, comprising:
an electro spray delivery device comprising:
a capillary tube having a proximal end in fluid communication with a source of conductive fluid and a distal end;
a solid guide wire coaxially disposed at least partially within the capillary tube to form an annular passage therein and having a distal tip projecting beyond the distal end of the capillary tube, wherein the conductive fluid receives an electrical charge as it flows through the annular passage and wets the distal tip of the guide wire; and
a grounding grid located a predetermined distance from the distal tip of the guide wire and in electrical communication with a source of ground, and having at least one thru-passage coaxially aligned with the capillary tube and guide wire; and
an atomization chamber adjacent the grounding grid and opposite the electrospray delivery device, wherein a voltage differential between the charged fluid and the grounding electrode pulls the charged fluid away from the distal end of the capillary tube and into a cone jet about an end face of the distal tip directing a stream of charged micro-droplets towards the at least one thru-passage and into the atomization chamber.

18) (canceled)

19) (canceled)

20) (canceled)

21) A method of making an electrospray delivery device for delivering a stream of charged micro-droplets of a conductive fluid, comprising:
obtaining a capillary tube having a proximal end and a distal end;
placing the proximal end of the capillary tube into fluid communication with a source of conductive fluid;
disposing a solid guide wire at least partially within the capillary tube to form an annular passage therein, and with a distal tip of the guide wire projecting beyond a distal end of the capillary tube, and at least one of the capillary tube and guide wire being conductive and in electrical communication with a high-voltage source to electrically charge the conductive fluid flowing through the annular passage; and
locating a grounding electrode in electrical communication with a source of ground at a predetermined distance from the distal end of the electrospray delivery device,
wherein a voltage differential between the charged conductive fluid and the grounding electrode pulls the charged fluid away from the distal end of the capillary tube and into a cone jet about an end face of the distal tip discharging an outwardly-directed stream of charged micro-droplets.

22) The method of claim 21, further comprising coating at least one of an internal surface of the capillary tube and an external surface of the guide wire with a material layer that facilitates wetting with respect to the conductive fluid.

23) The method of claim 21, further comprising coating the distal end of the capillary tube with a material layer that resists wetting with respect to the conductive fluid.

24) The method of claim 21, further comprising modulating a hydrostatic pressure of the source of conductive fluid to control a flow rate of the conductive fluid through the capillary tube.
